(19) United States
(12) Patent Application Publication
(10) Pub. No.: US 2017/0363086 A1
(43) Pub. Date: Dec. 21, 2017

(54) MODIFIED OIL PUMP FOR USE IN NON-OIL TRANSPORT

(71) Applicant: The Modern Group, Ltd., Beaumont, TX (US)

(72) Inventors: John David Aguilar, Conroe, TX (US); Ty Randolph Holbrook, Lumberton, TX (US); Bracken Phillip Jones, Hull, TX (US)

(21) Appl. No.: 15/186,037

(22) Filed: Jun. 17, 2016

(51) Int. Cl. F04D 9/04; F04D 13/12; F04D 15/00; F04D 13/02; F04D 29/22; F04D 29/42; F04D 29/62

(52) U.S. Cl. CPC F04D 9/041; F04D 29/426; F04D 13/12; F04D 29/628; F04D 13/02; F04D 29/22; F04D 15/0005; F05D 2230/60; F05D 2230/70

(57) ABSTRACT

The disclosed invention improves on self-priming centrifugal pumps. The improvements facilitate ease of maintenance by allowing the vacuum pulley belt to be changed without the need to disassemble the centrifugal pump to access the vacuum pulley belt. Additionally, issues with float valves becoming restricted leading to loss of prime conditions can be corrected with a disclosed invention.

### BACKGROUND

Centrifugal pumps are used to draw fluid from one location to another, but are limited in their ability to start without fluid already in them, known as dry conditions. Centrifugal pumps avoid operating in dry conditions by priming. Priming requires that fluid being transported by the centrifugal pump already be within the centrifugal pump from the source, at which point the centrifugal pump can begin to draw sufficient vacuum to continue drawing fluid. As long as there is a sufficient level of fluid in the centrifugal pump inlet from the fluid source through the centrifugal pump, the centrifugal pump maintains prime and operates normally.

The initialization and maintenance of prime is accomplished by a vacuum system independent of the centrifugal pump. The vacuum system comprises a vacuum pump and a float valve. The vacuum pump couples to the float valve via a hose. As the vacuum pump draws a vacuum, air is drawn from the float valve. The float valve connects to the centrifugal pump inlet, such that fluid does not enter the float valve until a sufficient level of fluid passes the eye of the impeller in the centrifugal pump. As more fluid enters the float valve, a float buoy nested inside the float valve rises. As the float buoy rises, a linkage guides the movement of the float buoy. Once the float buoy riding on top of the fluid in the float valve reaches a predetermined level, the linkage trips a seal on one end of the hose, preventing the fluid from entering the vacuum pump.

A standard configuration of such a centrifugal pump system with a vacuum pump involves an engine with the centrifugal pump and the vacuum pump projecting from the end of the engine. The centrifugal pump operates by the engine turning a driveshaft, which in turn rotates the impeller of the centrifugal pump. The driveshaft also drives a vacuum pulley belt that rotates a vacuum pulley wheel on the vacuum pump. As the vacuum pulley wheel turns, the vacuum pump receives power and can draw a vacuum when drawing fluid into a centrifugal pump.

An ongoing issue with the use of a vacuum pump is that the vacuum pump may develop a maintenance issue that prevents the centrifugal pump system from being used. The repairs may not be complex but can require the use of heavy equipment to perform the maintenance that can take several hours.

One of these issues arises when the vacuum pump loses power due to the vacuum pulley belt breaking or otherwise being compromised. The vacuum pulley belt is typically connected to the driveshaft near the junction of the centrifugal pump and the engine. If the vacuum pulley belt becomes compromised, then the entire centrifugal/vacuum pump system must be transported to a maintenance location in order to access the vacuum pulley belt. This can require an extensive commitment of time and labor. The centrifugal pump may have to be decoupled from the engine to remove the driveshaft so that a new vacuum pulley belt can encircle the driveshaft. Once the vacuum pulley belt encircles the driveshaft, the centrifugal pump must then be recoupled to the engine and the vacuum pulley belt must be reattached the vacuum pulley wheel.

Another issue involves the resetting of a float valve. In some configurations, the float valve has a float buoy that rests on top of the fluid in the float valve. These systems use a float buoy coupled to an arm that determines the fluid level by the position of the arm. Once the float buoy reaches a predetermined level, the vacuum pump is closed off from the float valve. Due to various issues, the float buoy may become fixed in a location and no longer accurately reflect the level of fluid in the float valve. It may be necessary to open the float valve to manually manipulate the float buoy to where if floats freely again.

Due to these and other concerns, there exists a need to have a vacuum pump coupled to a centrifugal pump that is easier to maintain.

### SUMMARY

The disclosed invention relates to maintenance of a centrifugal pump 102. Specifically the invention relates to the ability to change a vacuum pulley belt 126 on a centrifugal pump 102 designed to be self-priming. The disclosed invention and the various exemplary embodiments show how to access the vacuum pulley belt 126 without the need for extensive maintenance.

The disclosed invention also improves the operations of the float valve 132 used in the priming of the centrifugal pump 102 by installing a reset device 134 in the float valve 132. The reset device 134 prevents a float buoy 308 from restricting the vacuum dawn by the vacuum pump 120. In certain circumstances, a float buoy 308 may become fixed in a position that does not reflect the level of fluid 302 in the float valve 132. The reset projector 310 moves the float buoy 308 so that it may settle on the top of the fluid 302 in the float valve 132.

An additional improvement is that the disclosed invention may use a pump designed for oil transportation to transport water and other non-oil fluids.

### BRIEF DESCRIPTION OF FIGURES

FIG. 1 is a drawing of the overall pumping system in an exemplary embodiment with an indication of the location of the vacuum pulley access cover 128, with the vacuum pulley access cover 128 removed for illustrative purposes.

FIG. 2A is a drawing of a centrifugal pump stub shaft 106 and the engine stub shaft 138 fastened together with a stub shaft connector 136 while the vacuum pulley belt 126 is in communication with the vacuum pulley wheel 124 in an exemplary embodiment.

FIG. 2B is a drawing of a centrifugal pump stub shaft 106 and the engine stub shaft 138 from the exemplary embodiment from FIG. 2A with the stub shaft connector 136 and the vacuum pulley belt 126 removed.

FIG. 3A is a float valve 132 with the float buoy 308 in a position where the float valve 132 is open and the reset projector 310 is in the retracted position.

FIG. 3B is a float valve 132 from FIG. 3A with the float buoy 308 in a position where the float valve 132 is closed and the reset projector 310 is in the retracted position.

FIG. 3C is a float valve 132 from FIG. 3B with the float buoy 308 in a position where the float valve 132 is closed while the fluid 302 level is lower than the float buoy 308 and the reset projector 310 is in the retracted position.

FIG. 3D is a float valve 132 from FIG. 3C with the reset projector 310 has been triggered and is in the deployed position, moving the float buoy 308 and opening the float valve 132.

### DETAILED DESCRIPTION

A pump system in this exemplary embodiment has a centrifugal pump 102, an engine 142, a float valve 132, and a vacuum pump 120. The centrifugal pump 102 has a centrifugal pump inlet 104 that leads to the eye of the centrifugal pump volute 108. The impeller is mounted inside the centrifugal pump volute 108, and coupled to the driveshaft 202 from the engine 142. In an exemplary embodiment, the driveshaft 202 comprises a centrifugal pump stub shaft 106, an engine stub shaft 138, and a stub shaft connector 136 binding the two stub shafts together. The engine 142 is mounted on an engine support pedestal 140, while the centrifugal pump 102 is mounted on a centrifugal pump support pedestal 146 with additional support from the centrifugal pump volute pedestal 148.

The vacuum pump 120 is mounted on the centrifugal pump support pedestal 146 and the float valve 132 is mounted atop the centrifugal pump inlet 104. The vacuum pump 120 connects to the float valve 132 by a hose 130 connected to a vacuum chamber 144 that allows the vacuum pump 120 to draw a vacuum within the float valve 132. The float valve 132 opens into the centrifugal pump inlet 104. As the vacuum pump 120 draws a vacuum into the float valve 132, the fluid 302 enters the centrifugal pump inlet 104, filling the centrifugal pump inlet 104 with enough fluid to create a primed condition. As the fluid 302 enters the float valve 132, the float buoy 308 rises until it reaches the float valve output aperture 306 and creates a seal, preventing the fluid 302 from entering the vacuum pump 120 through the hose 130. In an exemplary embodiment, the vacuum pump 120 continues to operate when the float buoy 308 obstructs the float valve output aperture 306, but will not draw a vacuum in the centrifugal pump inlet 104 until the fluid 302 level in the float valve 132 lowers, causing the float buoy 308 to detach from the float valve output aperture 306.

The centrifugal pump 102 in an exemplary embodiment further comprises an independent lubrication system for maintaining the integrity of the seals of the centrifugal pump 102, where lubrication is maintained independently of the fluid 302 passing through the centrifugal pump 102. A lubricant reservoir 112 is coupled to the centrifugal pump support pedestal 146 and acts independently of the centrifugal pump 102, providing a continuous flow of lubrication to the centrifugal pump stub shaft 106 and the associated seals to prevent seal compromise even if the centrifugal pump 102 is running under dry conditions. A lubricant input hose 114 provides lubricant to the stuffing box 110, while a lubricant output hose 116 returns the lubricant back to the lubricant reservoir 112.

In an alternative exemplary embodiment, the centrifugal pump stub shaft 106 is lubricated by introducing a regular flow of lubricant into the areas surrounding the centrifugal pump stub shaft 106 in the stuffing box 110 by creating a mechanical seal to contain the lubricant. In an additional exemplary embodiment, the section of the centrifugal pump stub shaft 106 may be covered with a sleeve that is designed to facilitate the flow of lubricant around the centrifugal pump stub shaft 106.

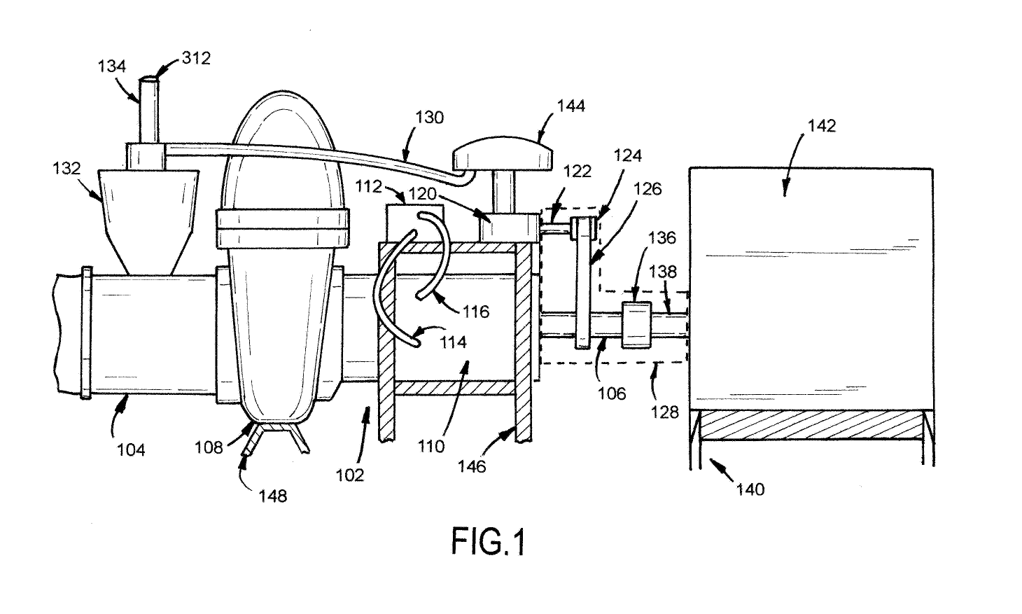

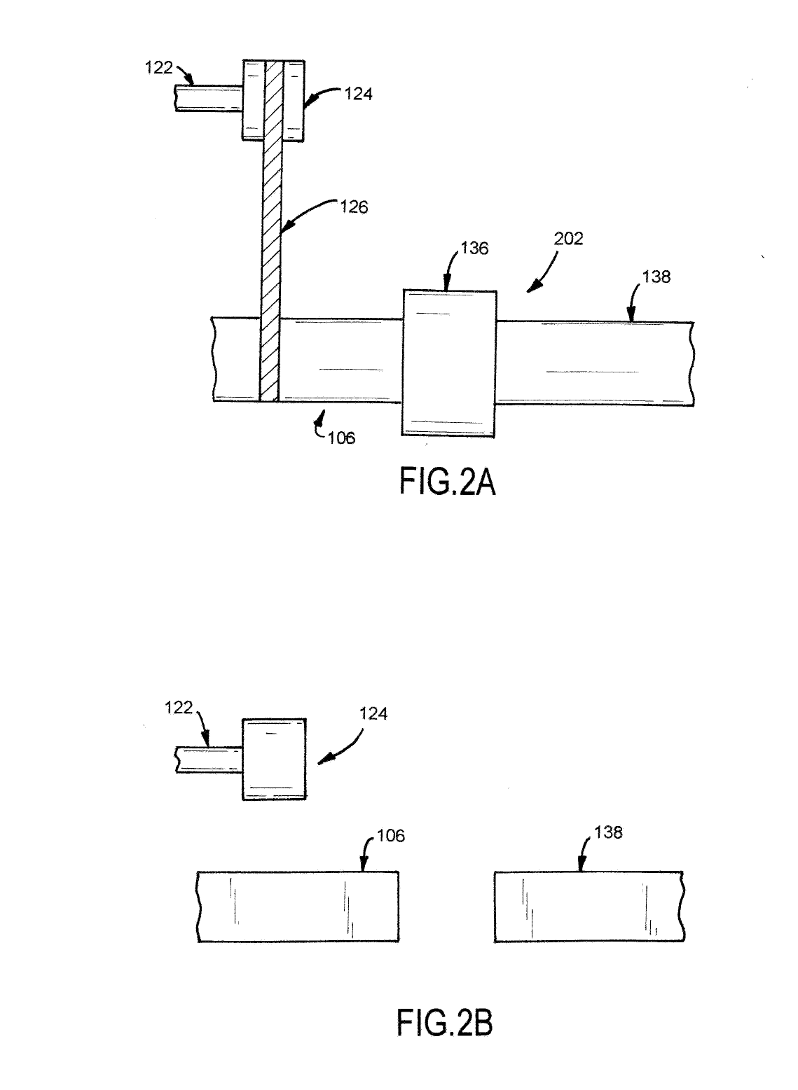

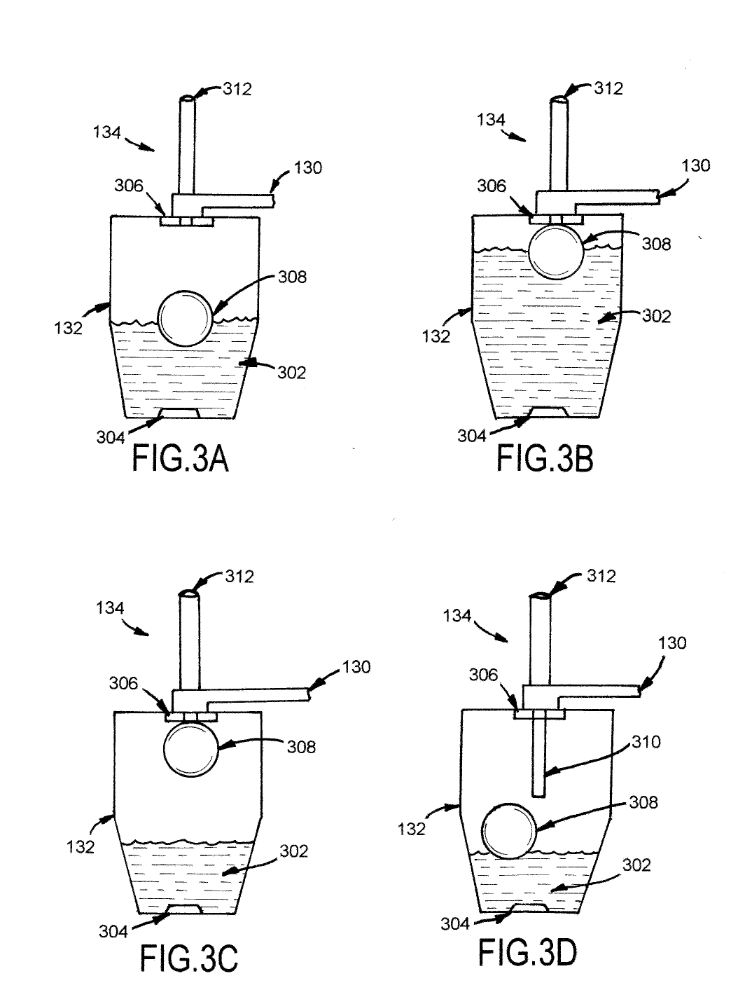

In an exemplary embodiment, there is a way to access the vacuum pulley belt 126 if maintenance is needed. The vacuum pump 120 in an exemplary embodiment is powered by a mechanical pulley system acting on the driveshaft 202. The vacuum pulley belt 126 loops around the driveshaft 202 and a vacuum pulley wheel 124 coupled to the vacuum pulley shaft 122. As the driveshaft 202 rotates, the vacuum pulley belt 126 rotates the vacuum pulley wheel 124, causing the vacuum pump 120 to operate. In an exemplary embodiment, the vacuum pulley belt 126 may be accessed by the removal of a vacuum pulley belt access cover 128. FIG. 1 shows the area that the vacuum pulley belt access cover 128 conceals when installed. Once the vacuum pulley belt access cover 128 is removed, the vacuum pulley belt 126 may be changed.

The installation of a new the vacuum pulley belt 126 occurs as a function of the connection between the engine 142 and the centrifugal pump 102. Since the engine 142 is supported by the engine pedestal 140 and the centrifugal pump 102 is supported by the centrifugal pump support pedestal 146 and the centrifugal pump volute support pedestal 148, the engine 142 and centrifugal pump 102 may be decoupled from each other without them moving. This allows the drive shaft 202 to be split by removing the stub shaft connector 136 without causing the engine 142 or the centrifugal pump 102 to move in relation to each other. The stub shaft connector 136 is decoupled from the engine stub shaft 138 and the centrifugal pump stub shaft 106, creating a gap between the engine stub shaft 138. The centrifugal pump stub shaft 106. To replace the vacuum pulley belt 126, the vacuum pulley belt 126 is placed between the centrifugal pump stub shaft 106 and the engine stub shaft 138, the stub shaft connector 136 is reattached, and the vacuum pulley belt 126 wraps around the centrifugal pump stub shaft 106 and the vacuum pulley wheel 124. This will cause the vacuum pulley wheel 124 to rotate along with the drive shaft 202. The vacuum pulley belt access cover 128 is then recoupled and the pumping system may resume operations. In an alternative embodiment, the vacuum pulley belt may wrap around the stub shaft connector 136 or the engine stub shaft 138.

In a further exemplary embodiment, the float valve 132 may require additional maintenance. The vacuum pump 120 causes air to be withdrawn from the float valve 132 through the hose 130. The vacuum will draw fluid 302 into the centrifugal pump inlet 104 and eventually into the float valve 132 through the float valve input aperture 304, increasing the fluid 302 in the float valve 132. The float buoy 308 will float on top of the fluid 302 until it reaches the top of the float valve 132, at which point the float buoy 308 will block the float valve output aperture 306, restricting the access from the float valve 132 to the vacuum pump 120. With the float buoy 308 in the float valve output aperture 306, the vacuum pump 120 is protected from fluid entering from the float valve 132. The vacuum pump 120 will act again on the float valve 132 when the float buoy 308 falls away from the float valve output aperture 306.

Due to multiple factors, the float buoy 308 may become lodged in the float valve output aperture 306. When this happens, the vacuum pump 120 cannot act to prime the centrifugal pump 102 if the prime is lost. In order to force the float buoy 308 free, a tool may act on the float buoy 308. In an exemplary embodiment, a reset device 134 is incorporated in the float valve 132. In an exemplary embodiment, the reset device 134 comprises a reset projector 310 coupled to a trigger 312. When a float buoy 308 becomes lodged within the float valve output aperture 306, the reset device 134 is activated. A user presses the trigger 312, which forces the reset projector 310 down through the float valve output aperture 306 to make contact with the float buoy 308. The reset projector 310 dislodges the float buoy 308, allowing the vacuum pump 120 to act on the float valve 132 until the float buoy 308 nests within the float valve output aperture 306 again. When the trigger 312 is released, the reset projector 310 retracts.

One of skill in the art will appreciate that the disclosed exemplary embodiments provide improvements to a centrifugal pump 102. One of these improvements involves the ability to adapt a pump designed for oil transportation into a pump that may transport water or other non-oil based fluids. Although specific embodiments are illustrated and described herein, it will be appreciated by those of ordinary skill in the art that any arrangement which is calculated to achieve the same purpose can be substituted for the specific embodiments shown. This specification is intended to cover any adaptations or variations of embodiments. For example, although described in terms of the specific embodiments, one of ordinary skill in the art will appreciate that implementations can be made in different embodiments to provide the required function. In particular, one of skill in the art will appreciate that the names and terminology are not intended to limit embodiments. Furthermore, additional apparatus can be added to the components, functions can be rearranged among components, and new components corresponding to future enhancements and future physical devices used in embodiments can be introduced without departing from the scope of embodiments. The terminology used in this application is intended to include all embodiments and alternatives which provide the same functionality as described herein.

1. A self-priming fluid transport device comprising:
a. a centrifugal pump with a centrifugal pump inlet;
b. a centrifugal pump stub shaft coupled to said centrifugal pump;
c. a centrifugal pump power device;
d. a centrifugal pump power device stub shaft coupled to said centrifugal pump power device;
e. a stub shaft connector detachably coupled to said centrifugal pump stub shaft and said centrifugal pump power device stub shaft;
f. a vacuum pump;
g. a vacuum pump pulley belt in communication with said vacuum pump and at least one of said centrifugal pump stub shaft, said centrifugal pump power device stub shaft, or said stub shaft connector; and
h. a float valve in communication with said vacuum pump and said centrifugal; pump inlet.

2. The self-priming fluid transport device of claim 1,
a. wherein said vacuum pump draws a vacuum through said float valve; and
b. wherein said float valve is in communication while said centrifugal pump inlet such that fluid entering said float valve first enters said centrifugal pump inlet.

3. The self-priming fluid transport device of claim 1:
a. wherein said float valve further comprises a float valve output aperture and a float buoy;
b. wherein said float buoy rests on the surface of fluid in said float valve, and
c. wherein said float buoy obstructs said float valve output aperture when the level of said fluid reaches a level to position said float buoy against said float valve output aperture.

4. The self-priming fluid transport device of claim 1, further comprising a centrifugal pump support wherein said centrifugal pump may remain in place when decoupled from said centrifugal pump power device.

5. The self-priming fluid transport device of claim 1, further comprising:
a. a connector housing to cover said centrifugal pump stub shaft, said centrifugal pump power device stub shaft, said stub shaft connector; and
b. a detachable cover coupled to said connector housing;
c. wherein said centrifugal pump stub shaft, said centrifugal pump power device stub shaft, and said stub shaft connector are accessible when said detachable cover is decoupled from said connector housing.

6. The self-priming fluid transport device of claim 5, wherein said vacuum pulley belt may be removed when said stub shaft connector is decoupled from at least one of said centrifugal pump stub shaft and said centrifugal pump power device stub shaft.

7. The self-priming fluid transport device of claim 5, wherein said vacuum pulley belt may be installed when said stub shaft connector is decoupled from said centrifugal pump stub shaft and said centrifugal pump power device stub shaft.

8. The self-priming fluid transport device of claim 1, wherein said float valve comprises:
a. a float buoy; and
b. a float valve output aperture dimensioned to prevent said float buoy from leaving said float valve;
c. wherein said float valve restricts access to said vacuum pump when said float buoy reaches said float valve output aperture.

9. The self-priming fluid transport device of claim 1, wherein said vacuum pump draws fluid into said centrifugal pump.

10. The self-priming fluid transport device of claim 1, wherein said float valve further comprises an ejection mechanism capable of acting on a float buoy when activated.

11. The self-priming fluid transport device of claim 10, wherein said ejection mechanism further comprises a reset projector, a trigger device to deploy said reset projector, and a retraction mechanism to withdraw said reset projector.

12. The self-priming fluid transport device of claim 11, wherein said ejection mechanism deploys said reset projector through said float valve output aperture to act on said float buoy.

13. A method of installing a vacuum pulley belt between a vacuum pulley wheel and at least one stub shaft, comprising:
a. removing a detachable cover;
b. decoupling a stub shaft connector from said at least one stub shaft;
c. encircling said at least one stub shaft with said vacuum pulley belt;
d. extending said vacuum pulley belt to go around the edge of said vacuum pulley wheel;
e. coupling said stub shaft connector to said at least one stub shaft; and
f. attaching said detachable cover.
